(19) United States
(12) Patent Application Publication
(10) Pub. No.: US 2019/0335556 A1
(43) Pub. Date: Oct. 31, 2019

(54) Dimming controllers and dimming methods capable of receiving PWM dimming signal and DC dimming signal

(71) Applicant: Leadtrend Technology Corporation, Zhubei City (TW)

(72) Inventors: Chun Hsin Li, Zhubei City (TW); Wei Cheng Su, Zhubei City (TW); Ruei Jhih Jheng, Zhubei City (TW)

(21) Appl. No.: 16/507,778

(22) Filed: Jul. 10, 2019

Related U.S. Application Data
(63) Continuation-in-part of application No. 16/199,367, filed on Nov. 26, 2018, now Pat. No. 10,397,997.

(30) Foreign Application Priority Data
Dec. 13, 2017 (TW) 106143645
May 3, 2019 (TW) 108115378

(51) Int. Cl. H05B 33/08

(52) U.S. Cl. CPC H05B 33/0845; H05B 33/0809

(57) ABSTRACT

A dimming controller is capable of receiving a dimming signal to dim light-emitting device no matter the dimming signal is of DC or of PWM. A type identifier identifies whether the dimming signal received from an input node is of DC or of PWM. A multiplexer with an output is controlled by the type identifier and configured to provide at least a DC signal path and a PWM signal path both coupled between the input node and the output. The type identifier makes the multiplexer enable the DC signal path and interrupt the PWM signal path if the dimming signal is identified as of DC, and makes the multiplexer enable the PWM signal path and interrupt the DC signal path if the dimming signal is identified as of PWM.

### CROSS-REFERENCE TO RELATED APPLICATION

This application claims priority to and the benefit of Taiwan Application Series Number 108115378 filed on May 3, 2019, which is incorporated by reference in its entirety. This application also is a continuation-in-part application of U.S. application Ser. No. 16/199367 filed on Nov. 26, 2018, which is now allowable.

### BACKGROUND

The present disclosure relates generally to dimming controllers and dimming methods, and, more particularly, to dimming controllers suitable of receiving a dimming signal no matter it is a pulse-width-modulation (PWM) signal or a direct-current (DC) signal.

Light emitting diode (LED), due to its characteristics in high power efficiency, compact product size, and long lifespan, has been widely adapted by lighting appliances and backlight modules. Until recently, most of cold cathode fluorescent lamps (CCFL) in the backlight modules of TV or computer display panels, for example, are replaced by LED modules.

LED modules usually need dimming controllers to perform light dimming, so as to adjust the luminance of a display panel for example. There are two different methods in the art to dim the luminance of a LED module: PWM dimming and DC dimming. PWM dimming, also named digital dimming, employs a PWM or digital signal that jumps quickly back-and-forth between levels of “0” and “1” in logic to determine the duty cycle of a LED module, the ratio of the time when the LED module emits light to the cycle time of the PWM signal. For example, when the PWM signal is “1” in logic, the luminance of the LED module is in its maximum, and when the PWM signal is “0”, it is zero, not emitting light. In other words, PWM dimming makes a LED module blinking. In contrast, DC dimming, also known as analog dimming or resistive dimming, makes a LED module emitting light continuously while the luminance of the LED module corresponds to the voltage level of a DC or analog signal.

For having more market share, a dimming controller should accommodate a dimming signal no matter the dimming signal is of PWM or of DC, and provide appropriate luminance control.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 illustrates dimming controller 10 that controls the luminance of light-emitting device LT via power transistor MNDRV;

FIG. 2 demonstrates dimming controller 10a;

FIG. 3 shows the correlation between dimming signal S_{DIM}, saw-wave signal S_{SAW} and PWM signal S_{PWM};

FIG. 4 exemplifies the waveform of dimming signal S_{DIM};

FIG. 5 shows dimming methods 60a in use of dimming controller 10a in FIG. 2;

FIG. 6 demonstrates dimming controller 10b;

FIG. 7 shows dimming methods 60b in use of dimming controller 10b in FIG. 6;

FIG. 8 demonstrates dimming controller 10c;

FIG. 9 shows dimming method 60c in use of dimming controller 10c in FIG. 8;

FIG. 10 demonstrates dimming controller 10d; and

FIG. 11 shows dimming method 60d in use of dimming controller 10d in FIG. 10.

### DETAILED DESCRIPTION

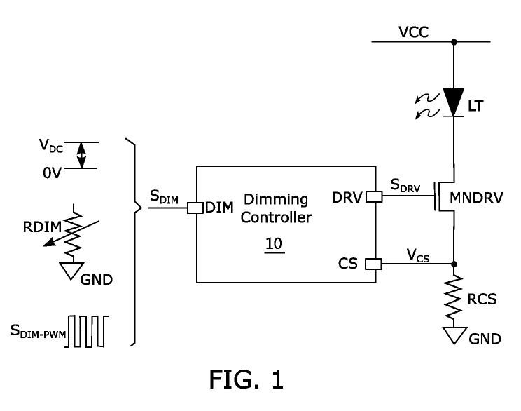

According to embodiments of the invention, FIG. 1 illustrates dimming controller 10 that controls the luminance of light-emitting device LT via power transistor MNDRV.

Power transistor MNDRV could be a NMOS transistor, acting as a current driver providing current with a proper magnitude to light-emitting device LT. Light-emitting device LT could be one or plurals of light-emitting diodes connected in series or in parallel. Dimming controller 10 provides driving signal S_{DRV} to the control gate of power transistor MNDRV. The current flowing through light-emitting device LT is monitored by dimming controller 10, as it is sensed by current-sense resistor RCS to provide current-sense signal V_{CS} at current-sense node CS. Dimming controller 10 receives dimming signal S_{DIM} from input node DIM to provide driving signal S_{DRV} accordingly.

As shown in FIG. 1, the configuration of dimming controller 10 enables three different kinds of external connection to perform dimming control. For the first one, external circuit (not shown) generates and provides DC voltage V_{DC} used as dimming signal S_{DIM} to input node DIM, and the voltage level of DC voltage V_{DC} represents the luminance of light-emitting device LT. For the second one, variable resistor RDIM connects between input node DIM and ground voltage GND, and the resistance of variable resistor RDIM is converted by dimming controller 10 into DC voltage V_{DC} representing the luminance of light-emitting device LT. How the resistance of variable resistor RDIM is converted into DC voltage V_{DC} at input node DIM will be detailed later on. For the third one, external circuit generates and provides PWM signal S_{DIM-PIM} used as dimming signal S_{DIM} to input node DIM, and the duty cycle of PWM signal S_{DIM-PWM} represents the luminance of light-emitting device LT.

In other words, dimming signal S_{DIM} could be of DC or of PWM. Dimming signal S_{DIM} could be categorized into one of two types: DC and PWM.

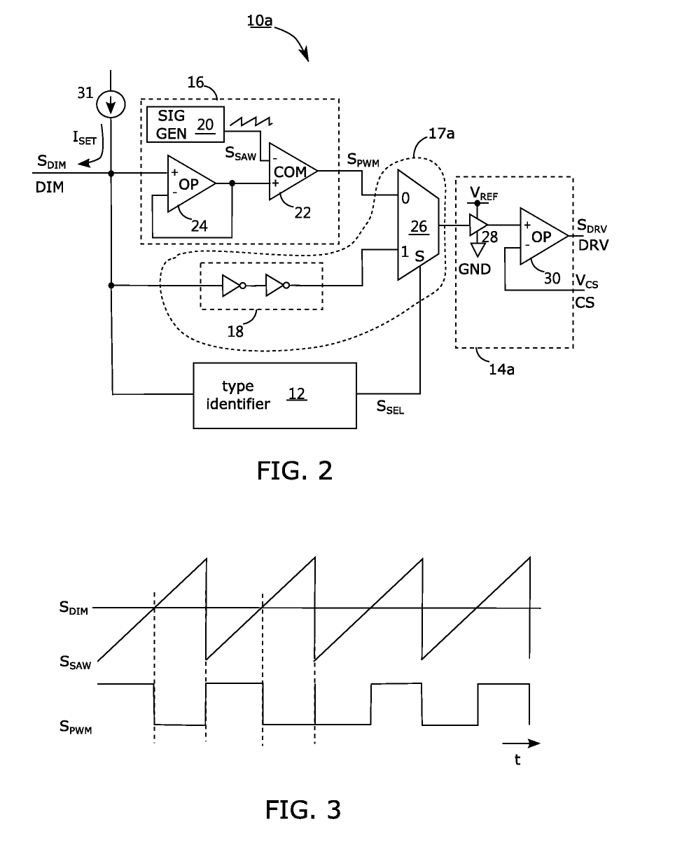

FIG. 2 demonstrates dimming controller 10a, which could be dimming controller 10 in FIG. 1 according to embodiments of the invention. Dimming controller 10a has type identifier 12, DC-to-PWM converter 16, multiplexer 17a, LED driver 14a, and constant current source 31.

DC-to-PWM converter 16 is a signal converter and, if dimming signal S_{DIM} is identified as of DC, DC-to-PWM converter 16 converts dimming signal S_{DIM} into PWM signal S_{PWM}. Shown in FIG. 2, DC-to-PWM converter 16 has signal generator 20, operational amplifier 24 and comparator 22. Please refer to FIG. 3, showing the correlation between dimming signal S_{DIM}, saw-wave signal S_{SAW} and PWM signal S_{PWM}. Configured as a unity-gain buffer, operational amplifier 24 reproduces the voltage level of dimming signal S_{DIM} at the non-inverting input of comparator 22. Signal generator 20 provides the inverting input of comparator 22 saw-wave signal S_{SAW}, which, like a clock, is periodically reset to its original starting voltage. Comparator 22 compares saw-wave signal S_{SAW} with dimming signal S_{DIM} to generate PWM signal S_{PWM}. As shown in FIG. 3, PWM signal S_{PWM} is “0” in logic when saw-wave signal S_{SAW} exceeds dimming signal S_{DIM}, and “1” in logic when saw-wave signal S_{SAW} is lower than dimming signal S_{DIM}.

Type identifier 12 is connected to input node DIM, for identifying whether dimming signal S_{DIM} at input node DIM is of DC or of PWM, and accordingly provides selection signal S_{SEL} to control multiplexer 17a. Type identifier 12 in FIG. 2 makes selection S_{DIM} “1” in logic if it identifies dimming signal S_{DIM} as of PWM, and “0” in logic if it identifies dimming signal S_{DIM} as of DC.

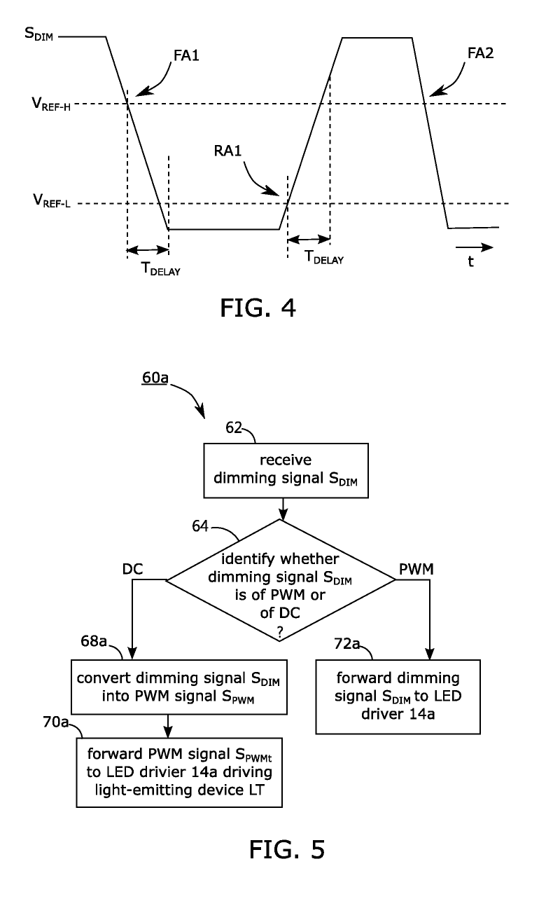

According to embodiments of the invention, selection signal S_{SEL} is determined in response to edges of dimming signal S_{DIM}. FIG. 4 exemplifies the waveform of dimming signal S_{DIM} that has two falling edges FA1 and FA2, and a rising edge RA1. Type identifier 12 provides selection signal S_{SEL} based on whether there are an enough number of significant edges within a predetermined period of time. An edge is significant to be an edge of a PWM signal when its tilt is large enough. For example, if there are more than 4 rising or falling edges found within a window of 8 ms and each of these edges has a slope whose absolute value exceeds 0.1V/us, type identifier 12 identifies dimming signal S_{DIM} as of PWM, making selection signal S_{SEL} “1” in logic. Two criteria must be satisfied to make selection signal S_{SEL} “1” in logic, for example. The first one is the count of rising or falling edges in a window of 8 ms must be larger than 4. The second one is each of these edges has a slope whose absolute value exceeds 0.1V/us. In the opposite, once type identifier 12 cannot find 4 edges, each having a tilt large enough, within a window of 8 ms for example, it identifies dimming signal S_{DIM} as of DC, making selection signal S_{SEL} “0” in logic.

Taking the waveform in FIG. 4 for example, type identifier 12, according to an embodiment of the invention, deems falling edge FA1 starting when dimming signal S_{DIM} goes down below reference voltage V_{REF-H} and starts a window of delay time T_{DELAY.} At the end of delay time T_{DELAY}, type identifier 12 compares dimming signal S_{DIM} with reference voltage V_{REF-L}, so as to know whether the absolute slope value of falling edge FA1 exceeds (V_{REF-H}−V_{REF-L})/T_{DELAY} or not. Analogously, type identifier 12 deems rising edge RA1 starting when dimming signal S_{DIM} goes up over reference voltage V_{REF-L} and starts another window of delay time T_{DELAY.} At the end of delay time T_{DELAY}, type identifier 12 compares dimming signal S_{DIM} with reference voltage V_{REF-H}, so as to know whether the absolute slope value of rising edge RA1 exceeds (V_{REF-H}−V_{REF-L})/T_{DELAY}. In another embodiment of the invention, type identifier 12 checks whether or not the falling time for dimming signal S_{DIM} going down from reference voltage V_{REF-H} to reference voltage V_{REF-L} is longer than delay time T_{DELAY}, so as to know whether a falling edge is significant enough to be a falling edge of a PWM signal. The rising time for dimming signal S_{DIM} rising from reference voltage V_{REF-L} to reference voltage V_{REF-H} is also compared with delay time T_{DELAY} to know whether a rising edge could be deemed as a rising edge of a PWM signal. If there are an enough number of edges each having an absolute slope value larger than (V_{REF-H}−V_{REF-L})/T_{DELAY}, then dimming signal S_{DIM} looks like a PWM signal, and selection signal S_{SEL} becomes “1”. Otherwise, dimming signal S_{DIM} should be a DC signal, and selection signal S_{SEL} becomes “0”.

Multiplexer 17a in FIG. 2 has digital buffer 18 and multi-input, single-output switch 26. Digital buffer 18 is a signal buffer that reproduces and provides dimming signal S_{DIM} to multi-input, single-output switch 26 if dimming signal S_{DIM} is identified as of PWM. Controlled by type identifier 12, multiplexer 17a has two inputs receiving PWM signal S_{PWM} and dimming signal S_{DIM} respectively. When type identifier 12 identifies dimming signal S_{DIM} as of DC, multiplexer 17a is controlled to select PWM signal S_{PWM} and forward it to LED driver 14a, while isolating dimming signal S_{DIM} from LED driver 14a. When type identifier 12 identifies dimming signal S_{DIM} as of PWM, multiplexer 17a isolates PWM signal S_{PWM} from LED driver 14a, and digital buffer 18 passes dimming signal S_{DIM} on to multi-input, single-output switch 26, which, as controlled by selection signal S_{SEL}, forwards dimming signal S_{DIM} to LED driver 14a. What multiplexer 17a outputs to LED driver 14a is always a PWM signal, which is either dimming signal S_{DIM} or PWM signal S_{PWM}, where PWM signal S_{PWM} represents dimming signal S_{DIM} when dimming signal S_{DIM} is of DC.

Selection signal S_{SEL} shown in FIG. 2 controls multiplexer 17a only, but the invention is not limited to however. According to embodiments of the invention, when dimming signal S_{DIM} is identified as of PWM, DC-to-PWM conversion is unnecessary, so type identifier 12 sends selection signal S_{SEL} to disenable or shut down DC-to-PWM converter 16, saving electric power. In the opposite, if dimming signal S_{DIM} is identified as of DC, digital buffer 18 is optionally shut down or disenabled to save electric power.

LED driver 14a receives a PWM signal only, and controls power transistor MNDRV to regulate current flowing through light-emitting device LT in response to what multiple-input, single-output switch 26 outputs. If the output of multiple-input, single-output switch 26 is “1” in logic, level shifter 28 outputs reference voltage V_{REF}, and operational amplifier 30 makes the current through light-emitting device LT about V_{REF}/R_{CS}, where R_{CS} is the resistance of current-sense resistor RCS. If the output of multiple-input, single-output switch 26 is “0” in logic, level shifter 28 outputs 0V, and operational amplifier 30 makes the current through light-emitting device LT about 0.

Constant current source 31 provides constant current I_{SET}, which, if there is variable resistor RDIM connected between input node DIM and ground voltage GND, goes through variable resistor RDIM to generate at input node DIM DC voltage V_{DC} used as dimming signal S_{DIM}. Accordingly, constant current I_{SET} converts the resistance of variable resistor RDIM into DC voltage V_{DC}. While DC voltage V_{DC} or PWM signal S_{DIM-PWM} is directly supplied or defined from an external circuit with low output impedance, constant current I_{SET} could not affect DC voltage V_{DC} or PWM signal S_{DIM-PWM} since constant current I_{SET} is very small in magnitude.

FIG. 5 shows dimming method 60a in use of dimming controller 10a in FIG. 2.

In step 62, dimming controller 10a receives at input node DIM dimming signal S_{DIM}, which could be a PWM signal or a DC signal.

In step 64 following step 62, type identifier 12 identifies whether dimming signal S_{DIM} is of PWM or of DC, to generate selection signal S_{SEL}, which controls multiplexer 17a.

Step 68a follows step 64 if dimming signal S_{DIM} is identified as of DC. DC-to-PWM converter 16 converts dimming signal S_{DIM} into PWM signal S_{PWM}.

Step 70a, in response to selection signal S_{SEL} generated in step 64, makes multiplexer 17a select PWM signal S_{PWM} and forwards it to LED driver 14a, which drives light-emitting device LT accordingly. Meanwhile, the signal path for dimming signal S_{DIM} from input node DIM, via digital buffer 18, and to LED driver 14a is disconnected. In one embodiment of the invention, step 70a disenables or shuts down digital buffer 18.

Step 72a, in response to selection signal S_{SEL} that indicates dimming signal S_{DIM} as a PWM signal, makes multiplexer 17a select dimming signal S_{DIM} and forward it via digital buffer 18 and multiple-input, single-output switch 26 to LED driver 14a driving light-emitting device LT. Meanwhile, multiplexer 17a isolates PWM signal S_{PWM} from LED driver 14a.

Dimming controller 10a in FIG. 2 and dimming method 60a in FIG. 5 have advantages as follows. If dimming signal S_{DIM} is of DC, PWM signal S_{PWM} representing dimming signal S_{DIM} is generated for LED driver 14a to drive light-emitting device LT. If dimming signal S_{DIM} is of PWM, dimming signal S_{DIM} is forwarded honestly to LED driver 14a, which faithfully and quickly responds to turn ON or OFF light-emitting device LT. No matter dimming signal S_{DIM} is a PWM signal or a DC signal, dimming controller 10a can always provide a proper PWM signal to LED driver 14a to drive light-emitting device LT appropriately.

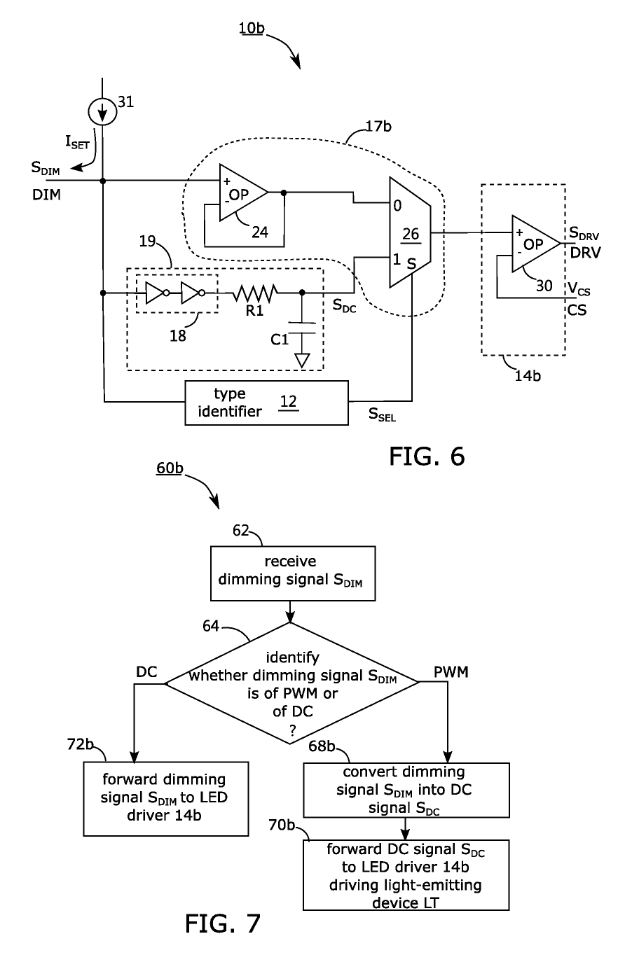

FIG. 6 demonstrates dimming controller 10b, which could be dimming controller 10 in FIG. 1 according to embodiments of the invention. Dimming controller 10b has type identifier 12, PWM-to-DC converter 19, multiplexer 17b, LED driver 14b, and constant current source 31. Several devices or circuits in FIG. 6 have been disclosed or taught by FIG. 2 and the relevant paragraphs, and their function and operation are not repeatedly detailed for brevity.

PWM-to-DC converter 19 is a signal converter and, if dimming signal S_{DIM} is of PWM, it is capable of converting dimming signal S_{DIM} into DC signal S_{DC}. Shown in FIG. 6, PWM-to-DC converter 19 has digital buffer 18, resistor R1 and capacitor C1. Digital buffer 18 reproduces the logic value of dimming signal S_{DIM} and provides it to resistor R1. Resistor R1 and capacitor C1 together form a low-pass filter, capable of generating DC signal S_{DC} whose voltage level represents the duty cycle of dimming signal S_{DIM}.

Multiplexer 17b in FIG. 6, controlled by type identifier 12, has two inputs receiving DC signal S_{DC} and dimming signal S_{DIM} respectively. Multiplexer 17b has operational amplifier 24 and multiple-input, single-output switch 26. When type identifier 12 identifies dimming signal S_{DIM} as of DC, operational amplifier 24, acting as a unity-gain buffer and a signal buffer, reproduces dimming signal S_{DIM} at its output and forwards dimming signal S_{DIM} to multiple-input, single-output switch 26, which continuously forwards dimming signal S_{DIM} to LED driver 14b, but blocks DC signal S_{DC} from reaching LED driver 14b. When type identifier 12 identifies dimming signal S_{DIM} as of PWM, multi-input, single-output switch 26 in FIG. 6, as controlled by selection signal S_{SEL}, forwards DC signal S_{DC} to LED driver 14b and blocks dimming signal S_{DIM} from reaching LED driver 14b. What multiplexer 17b outputs to LED driver 14a is always a DC signal, which is either dimming signal S_{DIM} or DC signal S_{DC}, where DC signal S_{DC} represents dimming signal S_{DIM} if dimming signal S_{DIM} is of PWM.

LED driver 14b receives a DC signal only, and controls power transistor MNDRV to regulate current flowing through light-emitting device LT in response to what multiple-input, single-output switch 26 outputs. If the output of multiple-input, single-output switch 26 has voltage level V_{OUT}, operational amplifier 30 makes the current through light-emitting device LT about V_{OUT}/R_{CS}.

FIG. 7 shows dimming method 60b in use of dimming controller 10b in FIG. 6. Some steps in FIG. 7 are the same or similar with corresponding steps in FIG. 5, so they are not repeatedly detailed here since they are comprehensible in view of related disclosure in the previous paragraphs.

Step 72b, in response to selection signal S_{SEL} that indicates dimming signal S_{DIM} is a DC signal, makes multiplexer 17b select dimming signal S_{DIM} and forward it via multiple-input, single-output switch 26 to LED driver 14b driving light-emitting device LT. Meanwhile, selection signal S_{SEL} causes multiplexer 17b to isolate DC signal S_{DC} from LED driver 14b.

Step 68b follows step 64 if dimming signal S_{DIM} is identified as of PWM. PWM-to-DC converter 19 converts dimming signal S_{DIM} into DC signal S_{DC}.

Step 70b, in response to selection signal S_{SEL} generated in step 64, follows step 68b. Step 70b makes multiplexer 17b select DC signal S_{DC} and forward it to LED driver 14b, which drives light-emitting device LT accordingly. Meanwhile, the signal path for dimming signal S_{DIM} from input node DIM, via operational amplifier 24, and to LED driver 14b is interrupted.

Selection signal S_{SEL} shown in FIG. 6 controls multiple-input, single-output switch 26 only, but the invention is not limited to however. According to embodiments of the invention, if dimming signal S_{DIM} is identified as of PWM, operational amplifier 24 is optionally shut down or disenabled to save electric power. Similarly, when dimming signal S_{DIM} is identified as DC, type identifier 12 sends selection signal S_{SEL} to disenable or shut down digital buffer 18, saving electric power.

Dimming controller 10b in FIG. 6 and dimming method 60b in FIG. 7 have advantages as follows. If dimming signal S_{DIM} is of DC, dimming signal S_{DIM} is forwarded honestly to LED driver 14b, which faithfully and analogically adjusts the current through light-emitting device LT. The current through light-emitting device LT is V_{OUT}/R_{CS} if the voltage level of dimming signal S_{DIM} is V_{OUT}. While dimming signal S_{DIM} is identified as PWM, DC signal S_{DC}, representing the duty cycle of dimming signal S_{DIM}, is generated and forwarded to LED driver 14b to drive light-emitting device LT. No matter dimming signal S_{DIM} is a PWM signal or a DC signal, dimming controller 10b can always provide a proper DC signal to LED driver 14b to drive light-emitting device LT appropriately.

This invention is not only useful for driving LEDs however, but could be also applicable for driving other kinds of lighting apparatuses.

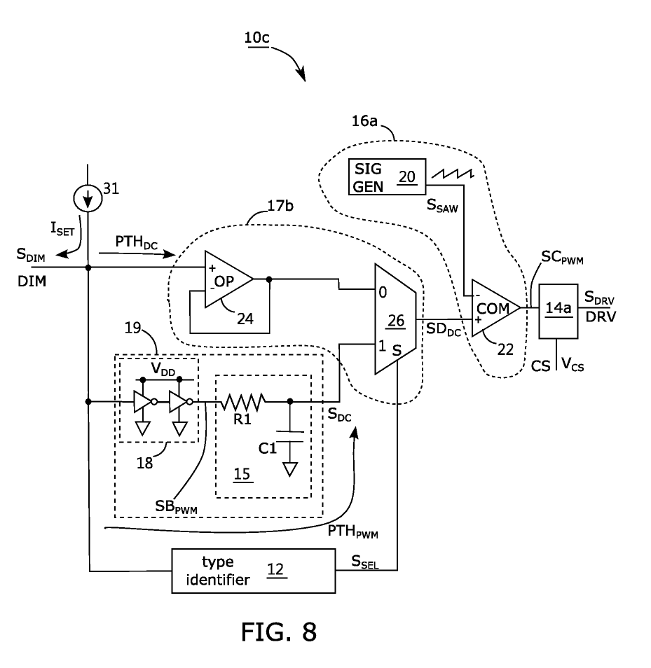

FIG. 8 demonstrates dimming controller 10c, which could be dimming controller 10 in FIG. 1 according to embodiments of the invention. Dimming controller 10c has type identifier 12, PWM-to-DC converter 19, multiplexer 17b, DC-to-PWM converter 16a, LED driver 14a, and constant current source 31. Several devices or circuits in FIG. 8 have been disclosed or taught by FIG. 2 or 6 and the relevant paragraphs, and their function and operation are not repeatedly detailed for brevity.

PWM-to-DC converter 19 is a signal converter, capable of converting dimming signal S_{DIM}, if it is identified as of PWM, into DC signal S_{DC}. Shown in FIG. 8, PWM-to-DC converter 19 includes digital buffer 18 and low-pass filter 15. Digital buffer 18 provides at an end of resistor R1 temporary PWM signal SB_{PWM}, which reproduces the logic value of dimming signal S_{DIM}. Resistor R1 and capacitor C1 together form low-pass filter 15, low-pass filtering temporary PWM signal SB_{PWM} to generate DC signal S_{DC} whose voltage level represents the duty cycle of dimming signal S_{DIM}.

The logic value of temporary PWM signal SB_{PWM} always follows that of dimming signal S_{DIM}, but temporary PWM signal SB_{PWM} might differ from dimming signal S_{DIM} in logic voltage level. For example, the logic voltage level of “0” in logic for both temporary PWM signal SB_{PWM} and dimming signal S_{DIM} is 0V, but the logic voltage level of “1” in logic for temporary PWM signal SB_{PWM} could be different from that for dimming signal S_{DIM}. Dimming signal S_{DIM}, which originates from an external circuit, could be 1V, 3V or 5V to represent “1” in logic, meaning the logic voltage level of dimming signal S_{DIM} for “1” in logic is 1V, 3V or 5V. The logic voltage level of temporary PWM signal SB_{PWM} for “1” in logic is predetermined internally by digital buffer 18, and could be a constant, 5V for example. Therefore, digital buffer 18 acts as a level shifter, and makes the logic voltage level of temporary PWM signal SB_{PWM} for logic “1” a predetermined constant regardless of the logic voltage level of dimming signal S_{DIM}.

Multiplexer 17b in FIG. 8, controlled by type identifier 12, has two inputs receiving DC signal S_{DC} and dimming signal S_{DIM} respectively. Multiplexer 17b has operational amplifier 24 and multiple-input, single-output switch 26. When type identifier 12 identifies dimming signal S_{DIM} as of DC, operational amplifier 24, acting as a unity-gain buffer and a signal buffer, reproduces dimming signal S_{DIM} and forwards it to multiple-input, single-output switch 26, which selects the output of operational amplifier 24 as DC signal SD_{DC} and provides it to DC-to-PWM converter 16a. Operational amplifier 24 transfers dimming signal S_{DIM} to multiple-input, single-output switch 26 if dimming signal S_{DIM} is of DC. When type identifier 12 identifies dimming signal S_{DIM} as of PWM, multi-input, single-output switch 26 in FIG. 6, as controlled by selection signal S_{SEL}, selects DC signal S_{DC} as DC signal SD_{DC} and provides it to DC-to-PWM converter 16a while blocking dimming signal S_{DIM} from reaching DC-to-PWM converter 16a. What multiplexer 17b outputs to DC-to-PWM converter 16a is always a DC signal, which is either dimming signal S_{DIM} or DC signal S_{DC}, where DC signal S_{DC} represents dimming signal S_{DIM} if dimming signal S_{DIM} is of PWM.

In FIG. 8 exist DC signal path PTH_{DC} and PWM signal path PTH_{PWM}, based on which the DC signal SD_{DC} is generated in response to dimming signal S_{DIM} at input node DIM. DC signal path PTH_{DC} goes from input node DIM, through operational amplifier 24 and multi-input, single-output switch 26, and to the non-inverting input of comparator 22. PWM signal path PTH_{PWM} goes from input node DIM, through digital buffer 18, low-pass filter 15 and multi-input, and single-output switch 26, and to the non-inverting input of comparator 22. If type identifier 12 identifies dimming signal S_{DIM} as of DC, type identifier 12 makes multi-input, and single-output switch 26 enable DC signal path PTH_{DC} and interrupt PWM signal path PTH_{PWM}. If type identifier 12 identifies dimming signal S_{DIM} as of PWM, type identifier 12 makes multi-input, and single-output switch 26 enable PWM signal path PTH_{PWM} and interrupt DC signal path PTH_{DC}.

Apparently, both digital buffer 18 and low-pass filter 15 are located on PWM signal path PTH_{PWM}, while operational amplifier 24 is located on DC signal path PTH_{DC}.

DC-to-PWM converter 16a converts DC signal SD_{DC} into PWM signal SC_{PWM}. Shown in FIG. 8, DC-to-PWM converter 16a has signal generator 20 and comparator 22. Signal generator 20 provides the inverting input of comparator 22 saw-wave signal S_{SAW}, which, like a clock, is periodically reset to its original starting voltage. Comparator 22 compares saw-wave signal S_{SAW} with DC signal SD_{DC} to generate PWM signal SC_{PWM}, analogous to what is taught in FIG. 3. The frequency of PWM signal SC_{PWM} is a constant determined by saw-wave signal S_{SAW}, and has nothing to do with the frequency of dimming signal S_{DIM} at input node DIM. Furthermore, the logic voltage level of PWM signal SC_{PWM} for logic “1” or “0” could be conveniently customized to fit in the input requirement of LED driver 14a.

LED driver 14a in FIG. 8 controls power transistor MNDRV in response to PWM signal SC_{PWM}, so as to control the current flowing through light-emitting device LT.

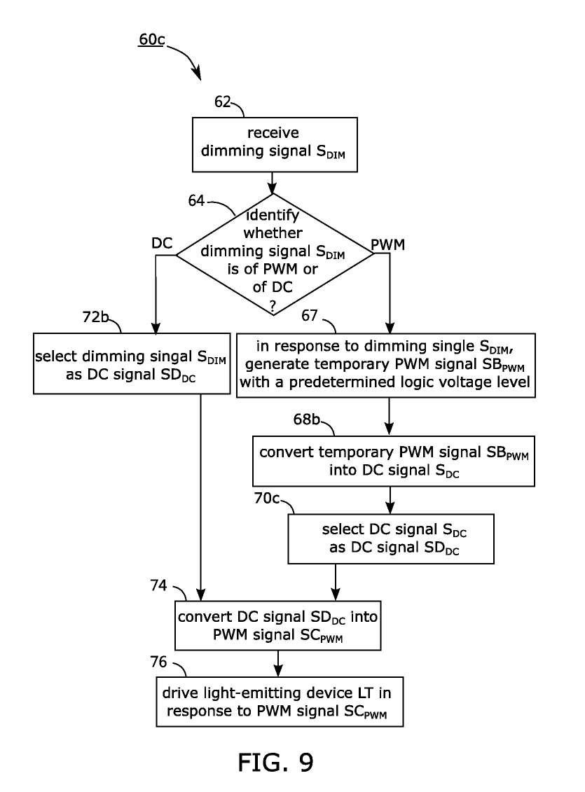

FIG. 9 shows dimming method 60c in use of dimming controller 10c in FIG. 8. Some steps of dimming method 60c are the same or similar with corresponding steps of dimming methods 60a and 60b, so they are not repeatedly detailed here since they are comprehensible in view of related disclosure in the previous paragraphs.

Step 72b, in response to selection signal S_{SEL} that indicates dimming signal S_{DIM} is a DC signal, makes multiplexer 17b enable DC signal path PTH_{DC} to generate DC signal SD_{DC} in response to dimming signal S_{DIM}. Step 72b also interrupts PWM signal path PTH_{PWM}, so multi-input, single-output switch 26 isolates DC signal SD_{DC} from DC signal S_{DC}.

Step 67 in FIG. 9 follows when type identifier 21 identifies dimming signal S_{DIM} as of PWM. Digital buffer 18 reproduces the logic value of dimming signal S_{DIM} to provide temporary PWM signal SB_{PWM}, which has a predetermined logic voltage level corresponding to a certain logic value.

In FIG. 9, step 68b follows step 67 and low-pass filer 15 converts temporary PWM signal SB_{PWM} into DC signal S_{DC}.

Step 70c of FIG. 9 follows step 68b. Step 70c makes multiplexer 17b select DC signal S_{DC} to be DC signal SD_{DC}. In other words, DC signal path PTH_{DC} is enabled to generate DC signal SD_{DC} in response to dimming signal S_{DIM}, and PWM signal path PTH_{PWM} is interrupted.

In step 74, DC-to-PWM converter 16a converts DC signal SD_{DC} into PWM signal SC_{PWM}.

Step 76, performed by LED driver 14a, controls power transistor MNDRV to control the current flowing through light-emitting device LT.

Dimming controller 10c in FIG. 8 and dimming method 60c in FIG. 9 have advantages as follows. Regardless whether dimming signal S_{DIM} is of PWM or of DC, dimming controller 10c could always generate corresponding PWM signal SC_{PWM}, which has a constant frequency and a predetermined logic voltage level, to dim the light-emitting device LT properly.

Multi-input, single-output switch 26 in dimming controller 10a, 10b or 10c is used to select one of two dimming signals with a common signal type. In dimming controller 10a, multi-input, single-output switch 26 selects one of two PWM signals. In dimming controller 10b and 10c, multi-input, single-output switch 26 selects one of two DC signals. This invention is not limited to, however. Multi-input, single-output switch 26 in other embodiments of the invention could select one of two dimming signals with different signal types.

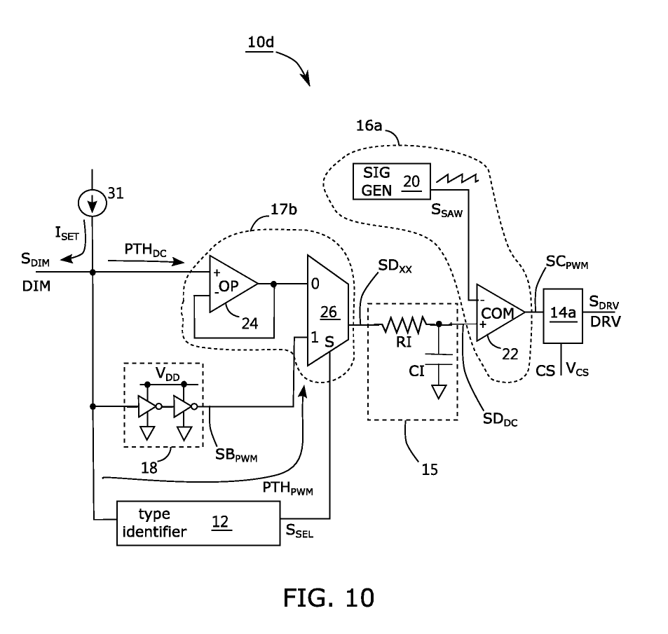

FIG. 10 demonstrates dimming controller 10d, which could be dimming controller 10 in FIG. 1 according to embodiments of the invention. Several devices or circuits in FIG. 10 have been disclosed or taught by dimming controller 10c in FIG. 8 and the relevant paragraphs, and their function and operation are not repeatedly detailed for brevity. Dimming controller 10d could have the same benefits or advantages with dimming controller 10c.

Please note that dimming controller 10c in FIG. 8 has low-pass filter 15 connected between multi-input, single-output switch 26 and digital buffer 18. Dimming controller 10d in FIG. 10, unlike dimming controller 10c, has low-pass filter 15 connected between multi-input, single-output switch 26 and comparator 22. In view of signal transmission, low-pass filter 15 in FIG. 8 provides signals to multi-input, single-output switch 26, while low-pass filter 15 in FIG. 10 receives signals from multi-input, single-output switch 26.

In FIG. 10, multiplexer 17b, which includes operational amplifier 24 and multi-input, single-output switch 26, selects one of dimming signal S_{DIM} and temporary signal SB_{PWM}, in response to selection signal S_{SEL} output from type identifier 12. The selected one is outputted as output SD_{XX} to low-pass filter 15 which accordingly generate DC signals SD_{DC}.

As shown in FIG. 10, when type identifier 12 identifies dimming single S_{DIM} as of DC, multiplexer 17b selects DC signal path PTH_{DC} to generate DC signal S_{DC}. Multi-input, single-output switch 26 selects the output from operational amplifier 24 to be output SD_{XX}, which reproduces dimming single S_{DIM} and is now a DC signal. Meanwhile, even though delays could occur due to signal propagation, low-pass filter 15 has no impact to the voltage level of dimming signal S_{DIM}, and can provide DC signal SD_{DC} that faithfully reproduces the voltage level of the dimming signal S_{DIM}.

In the other hand, when type identifier 12 in FIG. 10 identifies dimming single S_{DIM} as of PWM, multiplexer 17b selects PWM signal path PTH_{PWM} to generate DC signal SD_{DC}. Meanwhile, digital buffer 18 acts as a level shifter, and makes the logic voltage level of temporary PWM signal SB_{PWM} for logic “1” a predetermined constant regardless of the logic voltage level of dimming signal S_{DIM}. Multi-input, single-output switch 26 now selects temporary PWM signal SB_{PWM} to be output SD_{XX}, which is now a PWM signal. Low-pass filter 15 in response low-pass filters output SD_{XX}to generate DC signal SD_{DC}. In other words, low-pass filter 15 PWM-to-DC converts output SD_{XX} or temporary PWM signal SB_{PWM} into DC signal SD_{DC}.

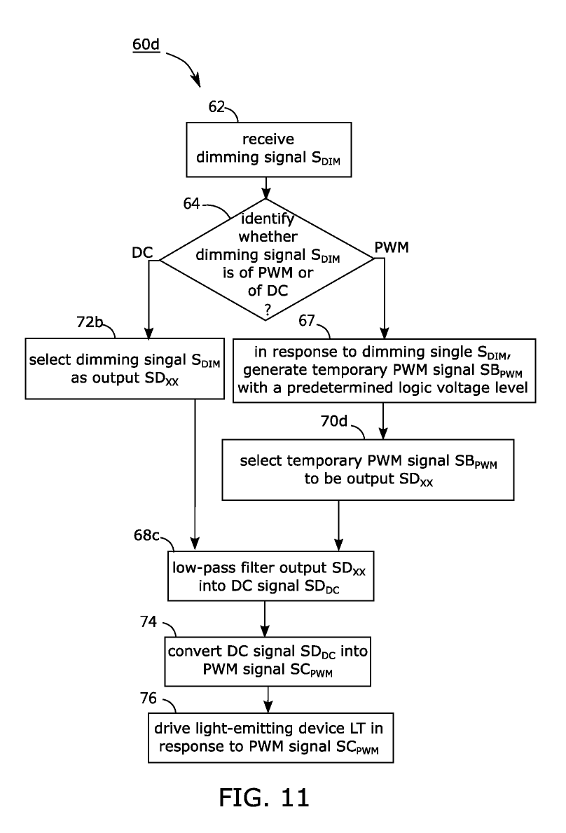

FIG. 11 shows dimming method 60d in use of dimming controller 10d in FIG. 10. Some steps of dimming method 60d are the same or similar with corresponding steps of dimming method 60c, so they are not repeatedly detailed here since they are comprehensible in view of related disclosure in the previous paragraphs.

Dimming method 60d, unlike dimming method 60c, have step 70d following step 67, where step 70 selects temporary PWM signal SB_{PWM} to be output SD_{XX}.

Dimming method 60d has step 68c followings both steps 72b and 70d. In step 68c, low-pass filter 15 low-pass filters output SD_{XX} to generate DC signal SD_{CS}.

While the invention has been described by way of example and in terms of preferred embodiment, it is to be understood that the invention is not limited thereto. To the contrary, it is intended to cover various modifications and similar arrangements (as would be apparent to those skilled in the art) . Therefore, the scope of the appended claims should be accorded the broadest interpretation so as to encompass all such modifications and similar arrangements.

What is claimed is:

1. A dimming controller for dimming a light-emitting device, comprising:
an input node for receiving a dimming signal used for dimming the light-emitting device;
a type identifier connected to the input node, for identifying whether the dimming signal is of DC or of PWM; and
a multiplexer with an output, the multiplexer controlled by the type identifier and configured to provide at least a DC signal path and a PWM signal path both coupled between the input node and the output;
wherein the type identifier makes the multiplexer enable the DC signal path and interrupt the PWM signal path if the dimming signal is identified as of DC, and makes the multiplexer enable the PWM signal path and interrupt the DC signal path if the dimming signal is identified as of PWM.

2. The dimming controller as claimed in claim 1, further comprising:
a digital buffer located on the PWM signal path, for generating a temporary PWM signal with a predetermined logic voltage level in response the dimming signal.

3. The dimming controller as claimed in claim 2, further comprising:
a PWM-to-DC converter for converting the temporary PWM signal into a DC signal dimming the light-emitting device.

4. The dimming controller as claimed in claim 3, further comprising:
a DC-to-PWM converter for converting the DC signal into a PWM signal dimming the light-emitting device.

5. The dimming controller as claimed in claim 4, wherein the PWM-to-DC converter is coupled between the digital buffer and the multiplexer.

6. The dimming controller as claimed in claim 4, wherein the PWM-to-DC converter is coupled between the multiplexer and the DC-to-PWM converter.

7. The dimming controller as claimed in claim 4, wherein the DC-to-PWM converter comprises:
a signal generator providing a periodical signal; and
a comparator comparing the periodical signal with the DC signal to generate the PWM signal.

8. The dimming controller as claimed in claim 3, wherein the PWM-to-DC converter includes a low-pass filter.

9. The dimming controller as claimed in claim 1, wherein the multiplexer comprises a unity-gain buffer located on the DC signal path, the unity-gain buffer transferring the dimming signal when the dimming signal is of DC.

10. A control method for dimming a light-emitting device, comprising:
receiving a dimming signal;
identifying whether the dimming signal is either of PWM or of DC;
providing a DC signal path and a PWM signal path;
enabling the DC signal path and interrupting the PWM signal path when the dimming signal is identified as of DC, so as to generate a first signal in response to the dimming signal, wherein the first signal is for dimming the light emitting device; and
enabling the PWM signal path and interrupting the DC signal path when the dimming signal is identified as of PWM, so as to generate the first signal in response to the dimming signal.

11. The control method as claimed in claim 10, comprising:
generating a temporary PWM signal in response to the dimming signal when the dimming signal is identified as of PWM, wherein the temporary PWM signal has a predetermined logic voltage level.

12. The control method as claimed in claim 11, comprising:
PWM-to-DC converting the temporary PWM signal into the first signal.

13. The control method as claimed in claim 12, wherein the step of PWM-to-DC converting comprises:
low-pass filtering the temporary PWM signal to generate the first signal.

14. The control method as claimed in claim 12, further comprising:
DC-to-PWM converting the first signal into a PWM signal dimming the light emitting device.

15. The control method as claimed in claim 10, further comprising:
providing a unity-gain buffer located on the DC signal path, the unity-gain buffer generating the first signal when the dimming signal is identified as of DC.
